(19) United States
(12) Patent Application Publication
(10) Pub. No.: US 2011/0088317 A1
(43) Pub. Date: Apr. 21, 2011

(54) Retractable Reflective Wall

(76) Inventor: Jeffrey Goldberg, Watsonville, CA (US)

(21) Appl. No.: 12/836,585

(22) Filed: Jul. 15, 2010

Related U.S. Application Data
(60) Provisional application No. 61/252,439, filed on Oct. 16, 2009.

(51) Int. Cl. A01G 1/00; A47G 5/02; E06B 9/56; E06B 9/60; E06B 9/72

(52) U.S. Cl. 47/58.1 LS; 160/323.1; 47/1.1 R; 160/309; 160/313; 160/305; 160/311

(57) ABSTRACT

A retractable high-reflectivity wall provides improved lighting conditions for growing plants. The wall is retractable, so that it does not get in the way when the user wishes to work in the grow area. The wall can also be retracted so that it is easier to move, carry, reposition, resize, and/or remove as needed. The wall may be implemented as a sheet including a reflective surface adhered or otherwise mounted onto a flexible backing such as a vinyl surface for additional support/reinforcement. The resulting flexible reflective wall is mounted onto a roller assembly which allows the wall to be extended or retracted. A support bar can be affixed to the roller assembly via brackets or other hardware. The entire apparatus can be suspended from or affixed to a ceiling, wall, fixture, or other object, or it can be supported by a stand or other assembly.

### CROSS-REFERENCE TO RELATED APPLICATIONS

This application claims priority from U.S. Provisional Application No. 61/252,439, for “Retractable Reflective Wall,” filed on Oct. 16, 2009, which is incorporated herein by reference.

### BACKGROUND OF THE INVENTION

1. Field of the Invention

The present invention relates to reflective surfaces for enhancing light sources in plant growing areas.

2. Description of the Related Art

One of the challenges in indoor agriculture is ensuring that plants receive sufficient light. Reflective walls or screens can be used to improve efficiency by directing light from a natural or artificial light source to the grow area. Stray light that would otherwise be wasted is thereby reflected toward the plants.

Fixed, or stationary, reflective walls can become dirty when the user works in the grow area. For example, when the plants are sprayed externally with water or chemicals, the spray can accumulate on the reflective surface, causing the wall to lose reflectivity. This results in a net loss of light to the plant. Replacement of a fixed reflective wall can be expensive, cumbersome, and/or difficult.

Some growers use a reflective surface mounted onto Styrofoam or wood boards that can be moved or removed as needed. The reflective surface can thereby be removed from the grow area when the user is working, and can be reinstalled when the user is finished working. However, movement of these large boards can be cumbersome, and it may be difficult to find adequate storage for the boards when they are not in use.

Some growers use stationary reflective fabric material for the grow area walls; this material can be readily cleaned, but it generally fails to provide adequate reflective properties, and still requires periodic maintenance in the form of cleaning.

### SUMMARY OF THE INVENTION

According to various embodiments of the present invention, a retractable high-reflectivity wall is provided. The wall may be free-standing and/or supported by a stand, so that it does not rely on any external surfaces or objects for support. Alternatively, the wall may be suspended from a ceiling, fixture, hook, door, or other element. The wall is retractable, so that it does not get in the way when the user wishes to work in the grow area. By retracting the wall, the user can ensure that the wall does not get dirty when the user works. The wall can also be retracted, either manually or by automatic means such as a spring, motor, or other mechanism. Retraction of the wall allows it to be more easily moved, carried, repositioned, resized, and/or removed as needed. The wall of the present invention thus provides distinct advantages over prior art systems in which a reflective wall has a fixed position and/or is difficult to move.

In one embodiment, the retractable wall is provided as a reflective surface adhered or otherwise mounted onto a flexible backing such as a vinyl surface for additional support/reinforcement. The resulting flexible reflective wall is mounted onto a roller assembly which allows the wall to be extended or retracted. A support bar can be affixed to the roller assembly via brackets or other hardware. The entire apparatus can be suspended from or affixed to a ceiling, wall, fixture, or other object, and/or it can be supported by a stand or other assembly. In one embodiment, hooks in the support bar can be used for suspending the apparatus via twine, rope, wire, or the like. In another embodiment, brackets or other attachment hardware on the support bar can be used to affix the apparatus to a wall, ceiling, or the like. In one embodiment, the retractable wall includes a spring-loaded self-retracting feature; a chain or cord can be used to activate a friction brake to control the self-retracting feature. In other embodiments, a motorized mechanism can be used for extension and/or retraction of the wall.

The various embodiments of the present invention thus provide a reflective wall that avoids the problems and limitations of prior art reflective walls. In various embodiments, the reflective wall of the present invention can be easily moved, reconfigured, and/or stored, and provides a mechanism for limiting exposure of the reflective surface to dirt, water, and chemicals that can diminish its effectiveness.

### BRIEF DESCRIPTION OF THE DRAWINGS

The accompanying drawings illustrate several embodiments of the invention and, together with the description, serve to explain the principles of the invention.

FIG. 1A is a diagram depicting a retractable reflective wall in a partially retracted state, according to one embodiment of the present invention.

FIG. 1B is a diagram depicting a retractable reflective wall in a substantially extended state, according to one embodiment of the present invention.

FIG. 2 is a diagram depicting the use of two retractable reflective walls in an indoor agriculture setting.

FIG. 3 is a detail diagram depicting an example of a fastening clip for affixing the bottom of the retractable reflective wall to an object or surface, according to one embodiment.

FIG. 4 is an oblique view of a retractable reflective wall having a self-retracting feature, the wall being in a retracted state, according to one embodiment of the present invention.

FIGS. 5 and 6 are detail oblique views of a retractable reflective wall having a self-retracting feature, the wall being in a retracted state, according to one embodiment of the present invention.

FIG. 7 is a detail cutaway view depicting a retractable reflective wall having a self-retracting feature, according to one embodiment of the present invention.

FIG. 8 is a detail exploded view depicting components of a retractable reflective wall having a self-retracting feature, according to one embodiment of the present invention.

FIG. 9 is a flow diagram depicting a method of using a retractable reflective wall, according to one embodiment of the present invention.

FIG. 10 is diagram depicting a retractable reflective wall having a chain retractor, the wall being in a partially retracted state, according to one embodiment of the present invention.

FIG. 11 is a detail view depicting a retractable reflective wall having a chain retractor, according to one embodiment of the present invention.

FIG. 12 is a cutaway view depicting a retractable reflective wall having a chain retractor, according to one embodiment of the present invention.

### DETAILED DESCRIPTION OF THE EMBODIMENTS

The present invention is now described more fully with reference to the accompanying Figures, in which several embodiments of the invention are shown. The present invention may be embodied in many different forms and should not be construed as limited to the embodiments set forth herein. Rather these embodiments are provided so that this disclosure will be complete and will fully convey the invention to those skilled in the art.

In the following description, the invention is set forth as a retractable reflective wall suitable for use in providing light for growing plants. However, one skilled in the art will recognize that the invention can be implemented in other ways as well. For example, the retractable reflective wall can be used for other purposes and in other contexts. It will be apparent from the description provided herein that many other variations are possible, and that the particular embodiments set forth herein are intended to be exemplary and not limiting.

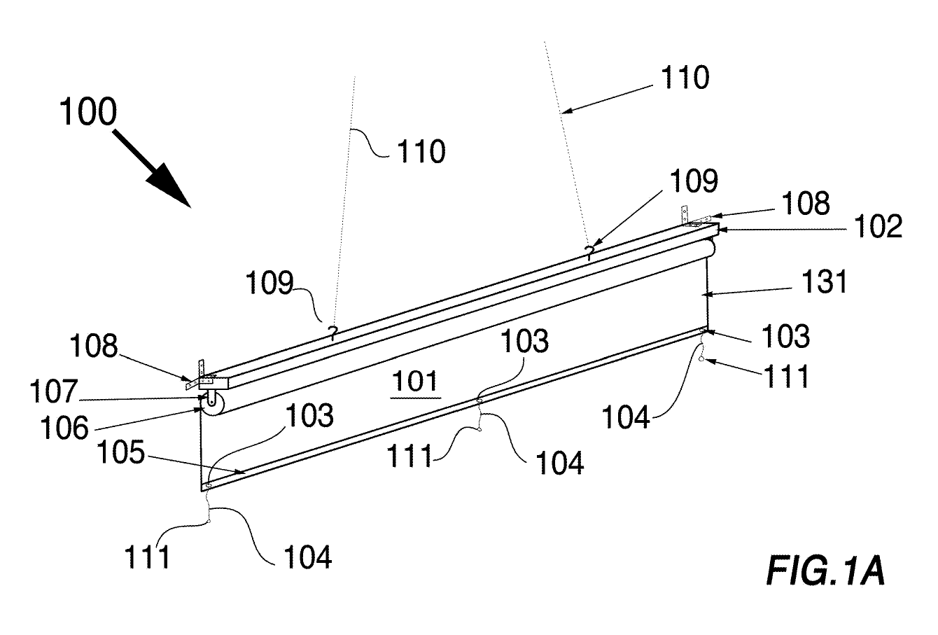

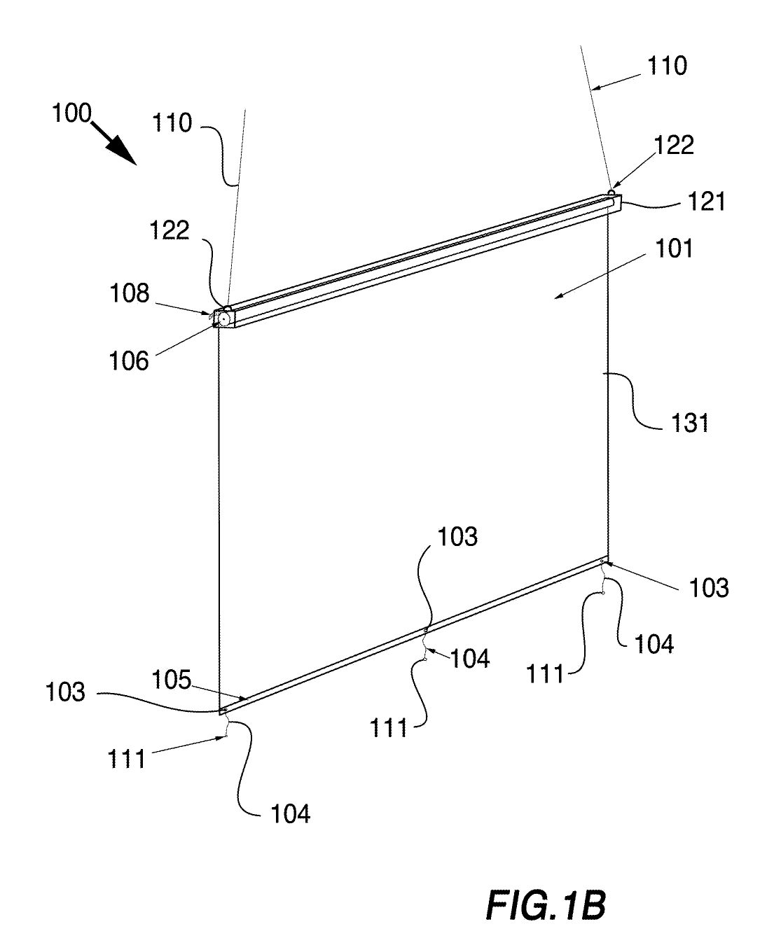

Referring now to FIG. 1A, there is shown retractable reflective wall 100 in a partially retracted state, according to one embodiment of the present invention. Support beam 102, which may be constructed of wood, plastic, metal, or any other material, can be suspended from a ceiling, wall, fixture, or other object (not shown), or it can be supported by a stand or other assembly (not shown), or is supported in some other way to allow it to be positioned above the grow area. For example, hooks 109 may be used for hanging beam 102 from a ceiling using twine 110, wire, string, rope, or the like. Brackets 108 may also be provided, in addition to or instead of hooks 109, to affix the apparatus to a wall, ceiling, or the like. One skilled in the art will recognize that other mechanisms may be used for supporting the assembly.

Brackets 107 attached to ends of support beam 102 hold spring-loaded roller assembly 106 in a manner that permits rotation of roller assembly 106 about an axis, so as allow the reflective wall of the present invention to be extended or retracted. Flexible sheet 131 is mounted onto roller assembly 106.

Referring also to FIG. 1B, there is shown retractable reflective wall 100 in a substantially extended state, according to one embodiment of the present invention. The apparatus of FIG. 1B is similar to that of FIG. 1A, except that support beam 102 is replaced by housing 121, which forms an outer shell surrounding and supporting roller assembly 106. Housing 121 may be constructed of plastic, wood, metal, or any other suitable material. In some embodiments, housing 121 may be preferable to support beam 102, as it hides roller assembly 106 and may therefore provide cosmetic advantages. FIG. 1B also depicts supports 122 in lieu of hooks 109, for attachment to twine 110. One skilled in the art will recognize that any support mechanism can be used.

In one embodiment, sheet 131 includes a highly reflective mirrored surface 101 that can be used to reflect light toward a grow area when extended from roller assembly 106. Reflective surface 101 can be on one or both sides of sheet 131. In one embodiment, reflective surface 101 is implemented using an aluminized plastic or polyester film such as Mylar®. In one embodiment, reflective surface 101 is formed or textured in order to provide better scattering of reflected light. Reflective surface 101 can be adhered or otherwise mounted onto a flexible backing such as a vinyl surface for additional support and reinforcement.

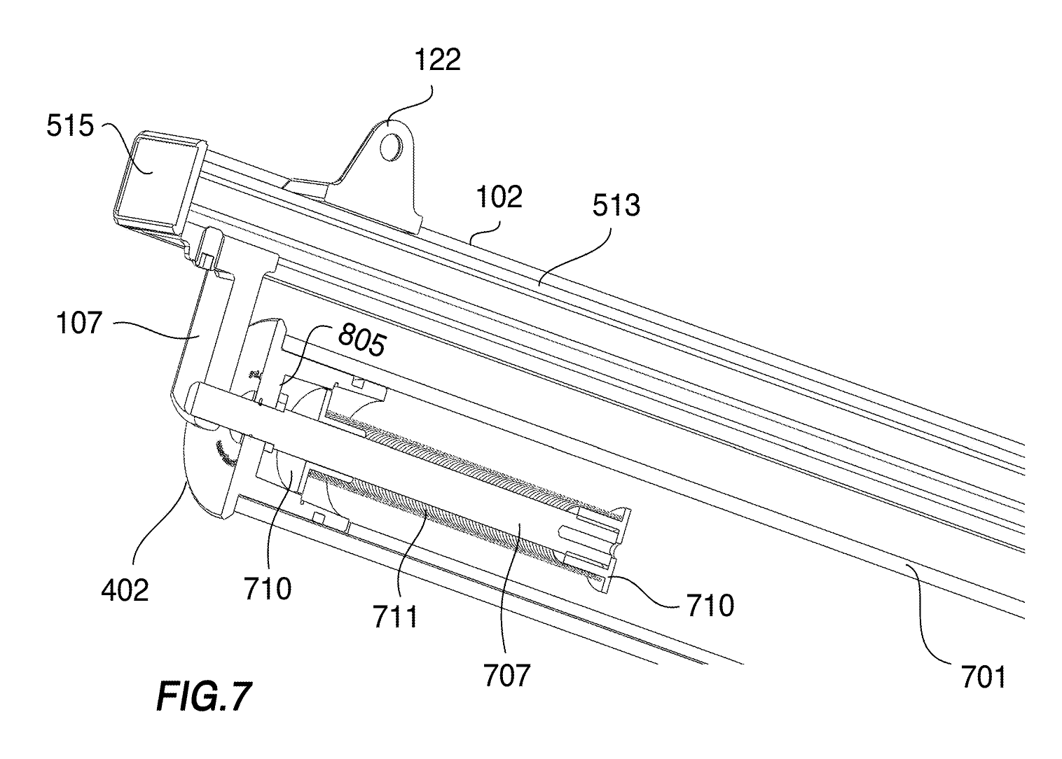

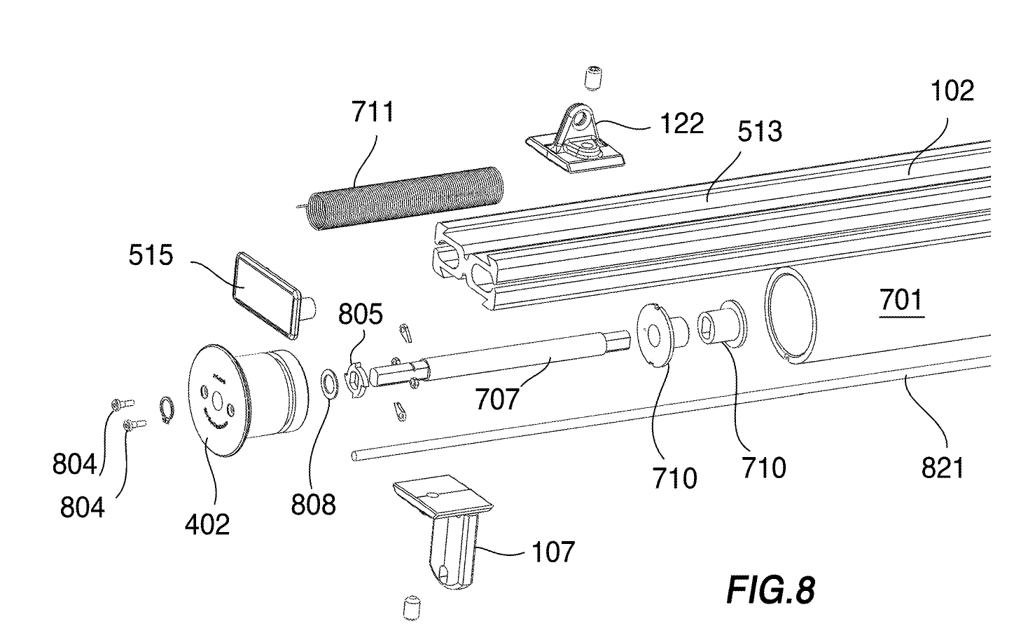

In one embodiment, roller assembly 106 includes a ratcheting spring assembly, similar to that found in a roller-type window blind, which allows sheet 131 to be extended and retracted as desired. In one embodiment, sheet 131 can be rolled or unrolled fully and/or partially to any desired extent, and can be configured to lock into any desired position. In one embodiment, a spring mechanism within the roller assembly provides for automatic retraction, for example if the user tugs on and then releases the bottom edge of sheet 131. In one embodiment, motorized extension and retraction of sheet 131 can also be implemented, for example by providing an electric motor (not shown) for rotating roller assembly 106 in either direction. Internal components of roller assembly 106 are described in more detail below in connection with FIGS. 7 and 8.

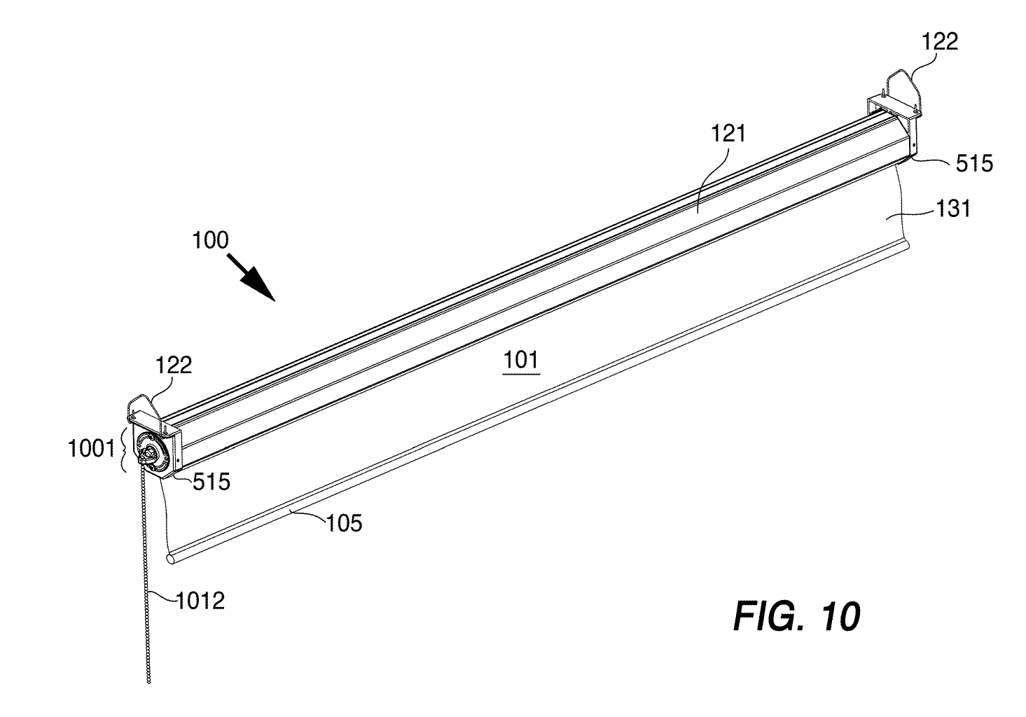

In another embodiment, a chain or cord can be provided for retracting sheet 131, as described in more detail below in connection with FIGS. 10 to 12.

One skilled in the art will recognize that retractable reflective wall 100 of the present invention can have any desired dimensions, depending on the length of support beam 102 and the dimensions of sheet 131. In one embodiment, the width of sheet 131 is between 2 and 8 feet, although any width can be provided. In one embodiment, the length of sheet 131 when fully extended is 55 inches, although any length can be provided.

In one embodiment, sheet 131, when extended, hangs from roller assembly 106. Rod 105 (or another type of weight) can be affixed to the bottom edge of sheet 131 so as to improve stability and limit movement resulting from wind, drafts, or other factors.

In one embodiment, a fastening mechanism, such as pull-down fasteners 104, can be provided to allow the bottom of sheet 131 to be affixed to a suitable object or surface; for example, fasteners 104 can attach to grommets 103 along the bottom edge of sheet 131, and can include hooks 111, clips, or other similar devices that attach to any suitable object or surface, such as the perimeter of a grow tray, or, in some cases, to the grow room floor itself. A cord or wire can be used to provide extended reach between the bottom edge of sheet 131 and the surface to which it is affixed. To retract sheet 131, connecting hooks 111 are disengaged either from the bottom edge of sheet 131 or from the surface or object to which hooks 111 are attached. Connecting hooks 111 or clips can reside on the bottom edge of sheet 131 itself or on the tray or other surface, with connection points being located so as to engage connecting hooks 111 or clips.

In various embodiments of the invention, the described pull-down fasteners 104 may be provided instead of or in addition to rod 105 or other weighting mechanism. Such a mechanism anchors retractable reflective wall 100 in its extended position.

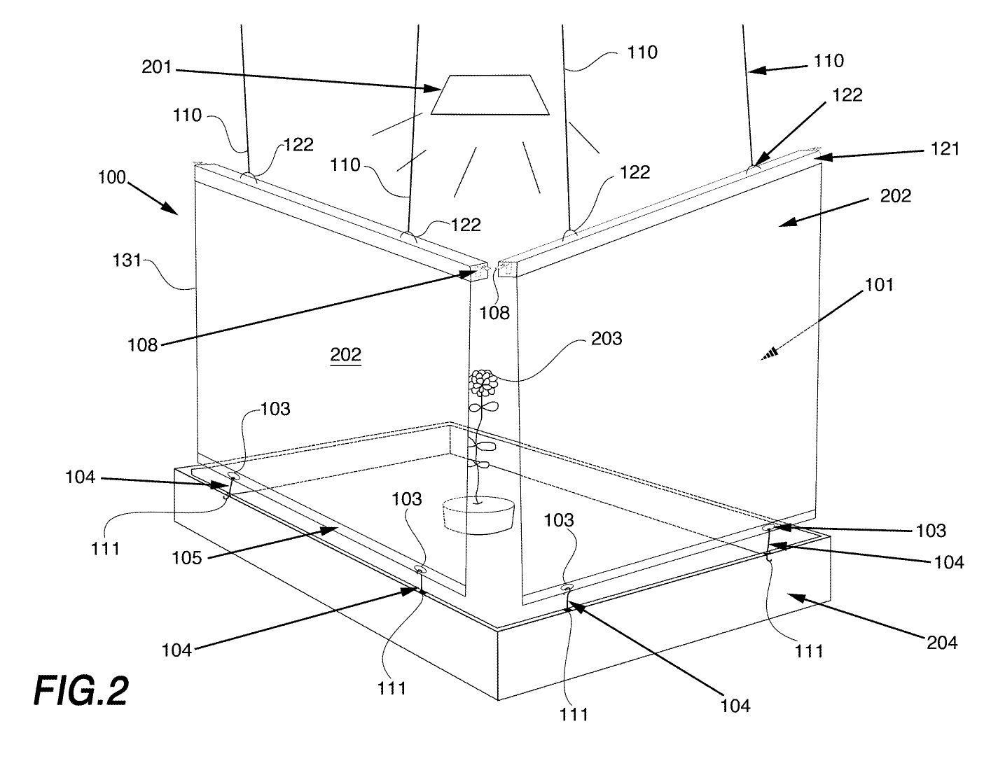

Retractable reflective wall 100 can thus be free-standing when in its extended position, so that the surface of retractable wall 100 need not be situated against a window, fixed wall, or other surface. Referring now also to FIG. 2, there is shown an arrangement in which two retractable reflective walls 100 are used in an indoor agriculture setting. FIG. 2 illustrates the use of the techniques of the present invention to implement retractable reflective walls 100 that can be situated in a free-standing manner surrounding a grow tray 204 or other grow area, without the need for any window, fixed wall, or other surface adjacent to or behind retractable reflective walls 100.

In FIG. 2, the two reflective walls 100 are situated so that they reflect light from lamp 201 onto plant(s) 203 growing in grow tray 204. The user can retract walls 100 when he or she wishes to work with plant(s) 203, such as to water them, so as to avoid damaging or soiling walls 100. Fasteners 104 affixed the bottom edge of sheet 131 to grow tray 204 for added stability, as described above. FIG. 2 also depicts vinyl backing 202 that can be provided as part of sheet 131 for additional strength and durability.

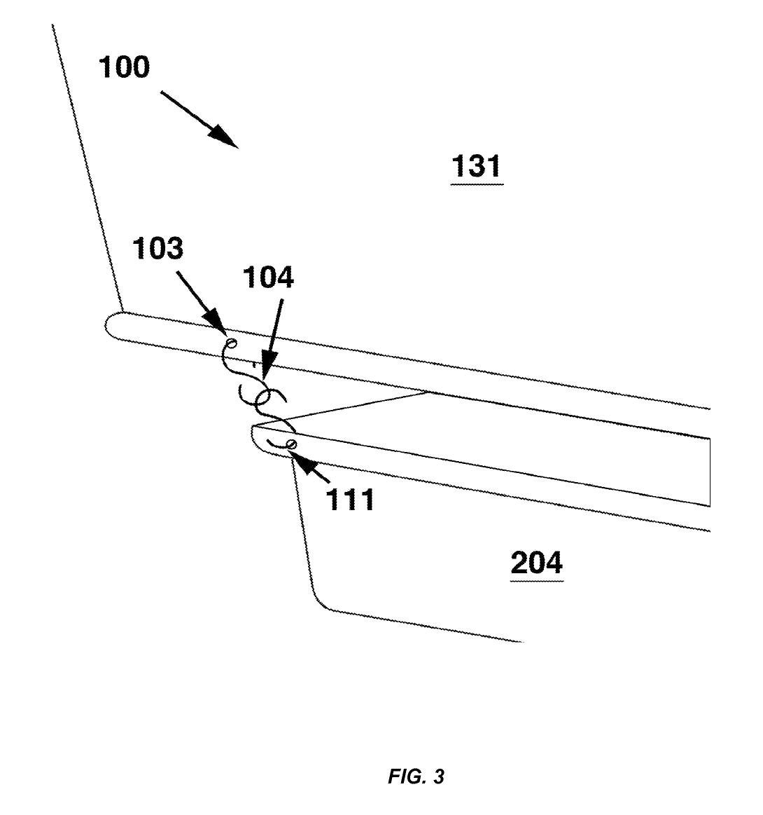

Referring now to FIG. 3, there is shown a detail diagram depicting an example of fastening clip 104. Clip 104 affixes the bottom edge of sheet 131 of retractable reflective wall 100 to an object or surface, according to one embodiment. In the example, clip 104 is attached to grommet 103 of sheet 131, and includes hook 111 which attaches to an edge of grow tray 204.

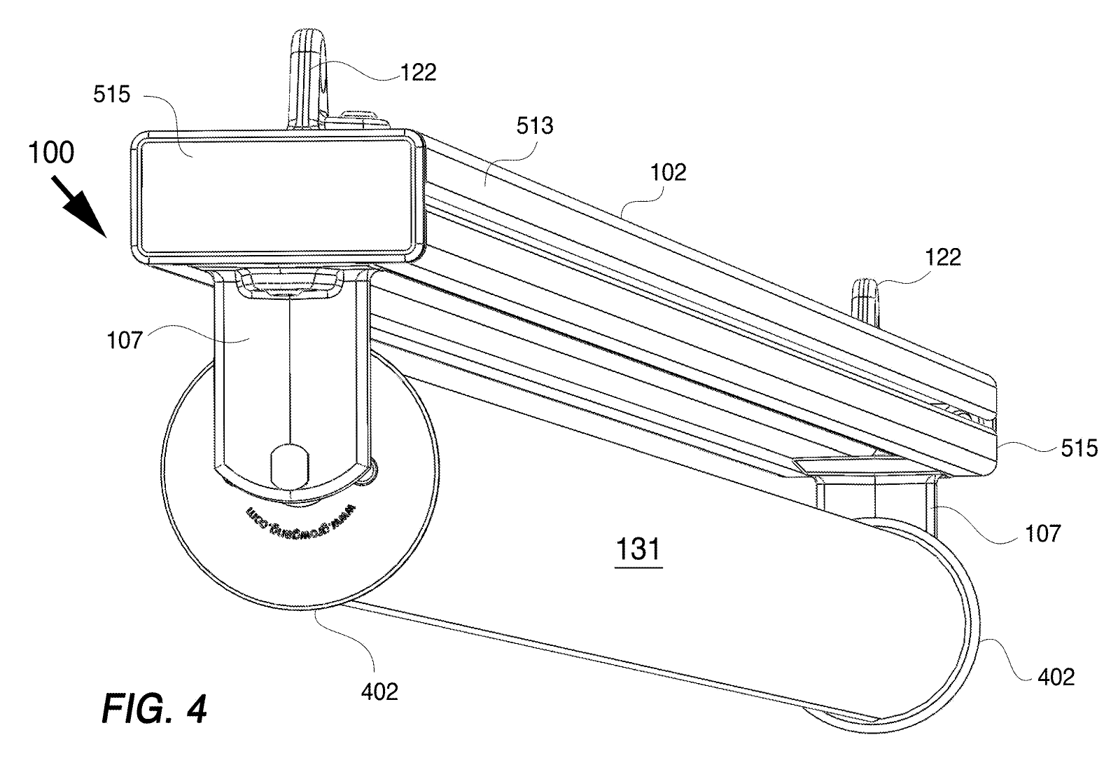

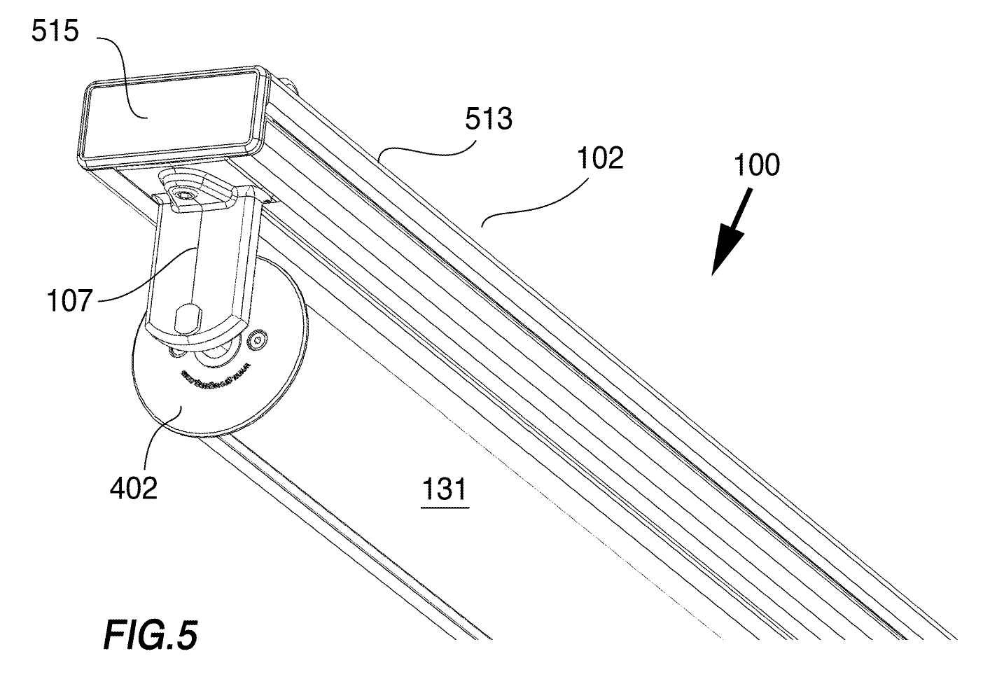

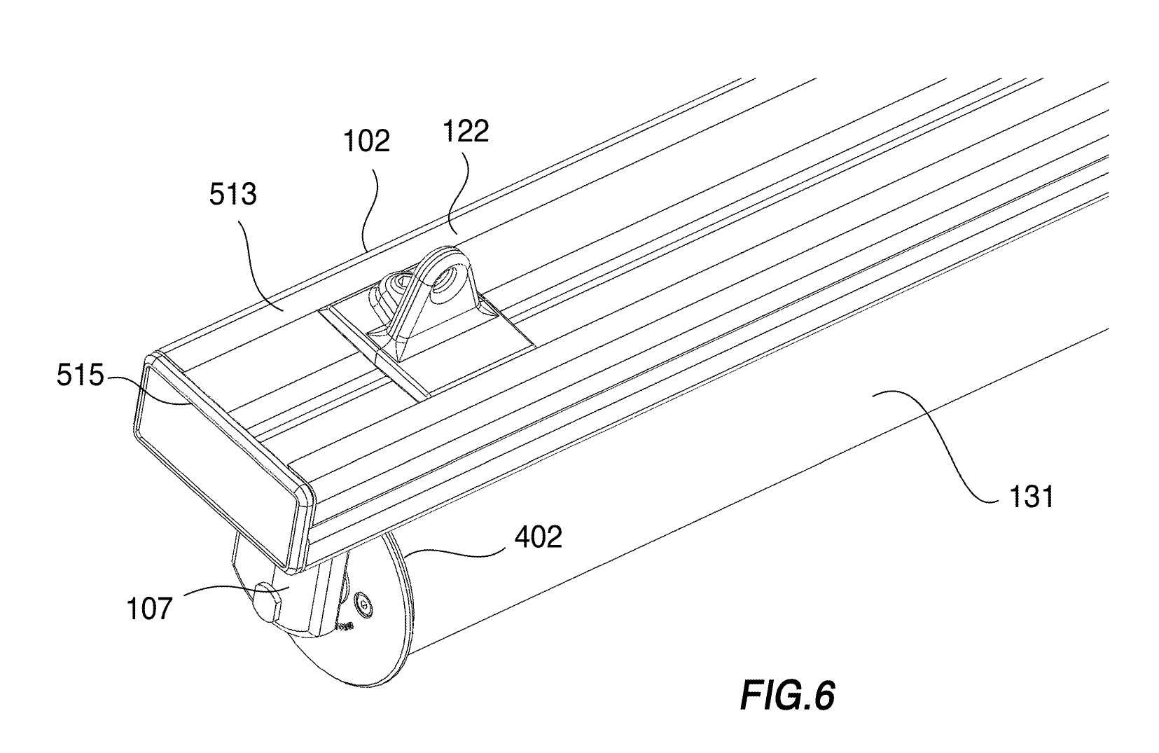

Referring now to FIGS. 4 through 6, there are shown oblique views of retractable reflective wall 100 in a retracted state, from various points of view, according to one embodiment of the present invention. As can be seen from FIGS. 4 through 6, beam 102 can be constructed from an extruded piece 513, with caps 515 affixed to either end. In one embodiment, supports 122 and brackets 107 are attached to extruded piece 513. Brackets 107 hold roller assembly 106, which includes a cylinder and inner axle (not shown in FIGS. 4 through 6) and end caps 402. Sheet 131 is rolled onto the cylinder between end caps 402.

Referring now to FIG. 7, there is shown a cutaway view depicting retractable reflective wall 100 having a self-retracting feature, according to one embodiment of the present invention. Referring also to FIG. 8, there is shown an exploded view depicting components of retractable reflective wall 100 having a self-retracting feature, according to one embodiment of the present invention. FIGS. 7 and 8 depict a particular internal structure that can be used in one embodiment for implementing the self-retracting feature, although one skilled in the art will recognize that other structures and arrangements may be used. Cylinder 701 contains inner axle 707 as well as spring 711. Spring 711 is held in place by collar 710, which may include caps at either end to keep spring 711 from sliding off. Spring 711 is compressed when sheet 131 is extended. Spring 711 exerts rotational force tending to cause cylinder 701 to rotate in a direction that will retract sheet 131. Cog catch 805 is used, in one embodiment, to keep spring's 711 compression from rotating cylinder 701 when sheet 131 is extended. When user tugs on sheet 131, cog catch 805 is released; spring's 711 compression then causes cylinder 701 to rotate so as to automatically retract sheet 131.

FIG. 8 depicts additional components that are used in one embodiment. Shoulder screws 804 hold inner axle 707, cap 402, and cylinder 701 in place. Washer 808 permits rotational movement of inner axle 707 with respect to cap 402. Also depicted in FIG. 8 is weighted rod 821, which may be affixed to or inserted into sheet 131, for example at a bottom edge.

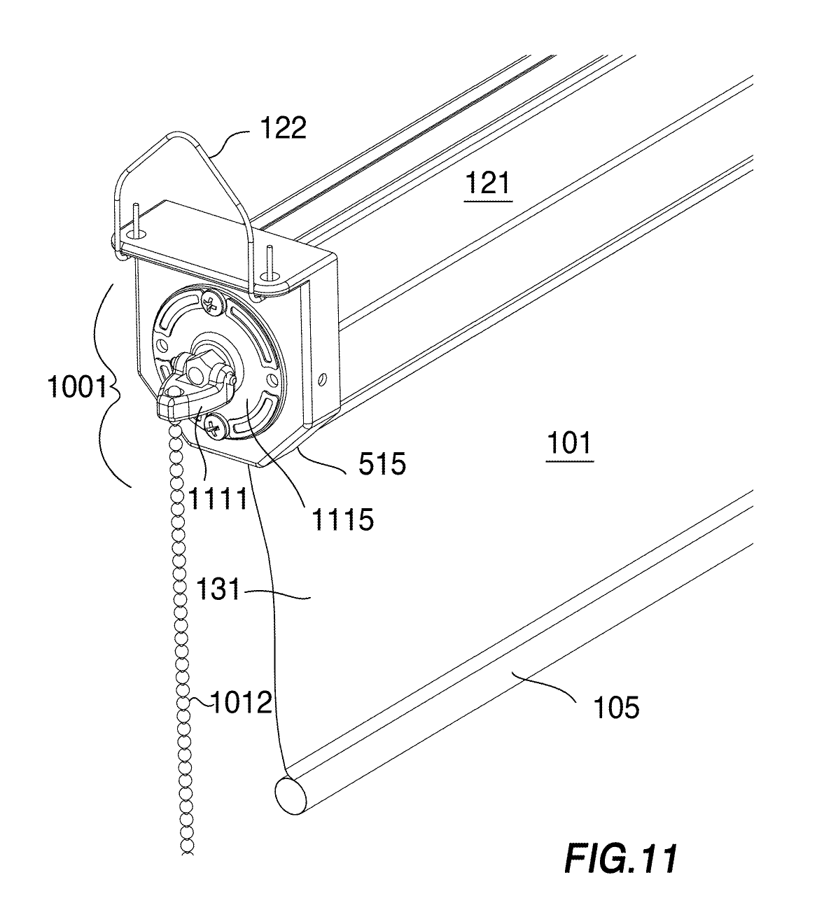

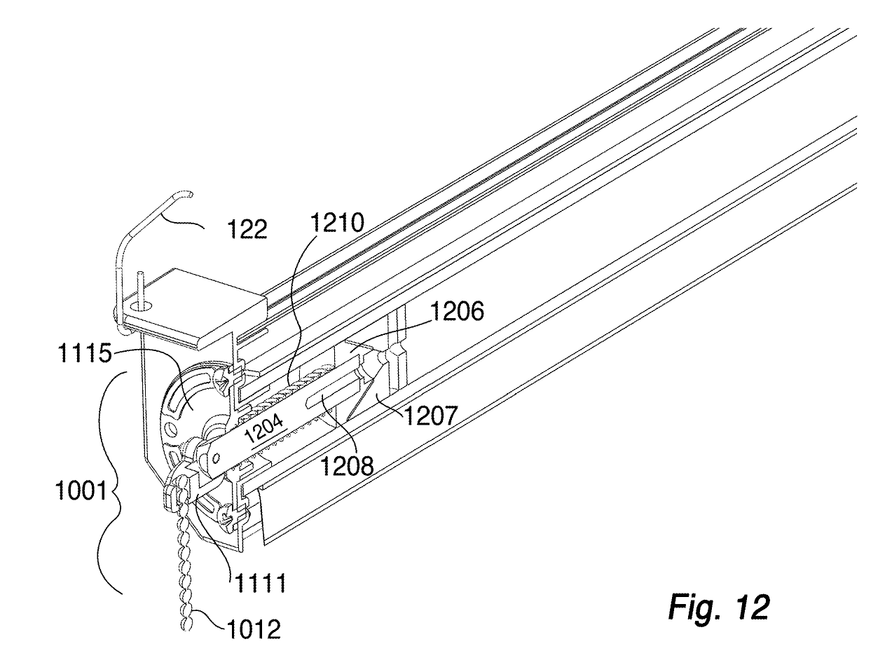

Referring now to FIG. 10, there is shown an embodiment in which retractable reflective wall 100 has a chain retractor. Referring now also to FIG. 11, there is shown a detail view depicting the chain retractor embodiment. Referring now also to FIG. 12, there is shown a cutaway view depicting the chain retractor embodiment.

In one embodiment, the embodiment depicted in FIGS. 10 through 12 operates as follows. Retractable wall 100 includes brake assembly 1001 for selectively holding sheet 131 in the extended position (or in a partially extended position) while allowing for automatic retraction when the user pulls on ball chain 1012. Brake assembly 1001 includes cone 1206, cone socket 1207, cone axle 1208, pull lever 1111, and end-cap port 1115. Spring 1210 provides for automatic retraction of sheet 131 by exerting force that tends to rotate spring axle 1204. Spring axle 1204 is connected to cone axle 1208 and cone 1206; friction between cone 1206 and cone socket 1207 prevents spring axle 1204 from rotating when brake assembly 1001 is engaged. The user disengages brake assembly 1001 by pulling on chain 1012; this causes pull lever 1111 to rotate in a downward direction against end-cap port 1115, pulling on spring axle 1204 and causing cone 1206 to disengage gradually from cone socket 1207. This brake mechanism allows the user to control the rate at which sheet 131 retracts, by maintaining any desired degree of friction between cone 1206 and cone socket 1207. The user can release chain 1012 at any time to re-engage brake assembly 1001 and thereby hold sheet 131 in any desired position, whether fully extended, fully retracted, or partially extended.

End cap 515 may optionally be provided to cover and/or hide the internal components of brake assembly 1001. Any type of chain, cord, wire, rod, or similar implement can be used in place of ball chain 1012.

In other embodiments, motorized and/or other mechanical means can be used for extending and/or retracting sheet 131.

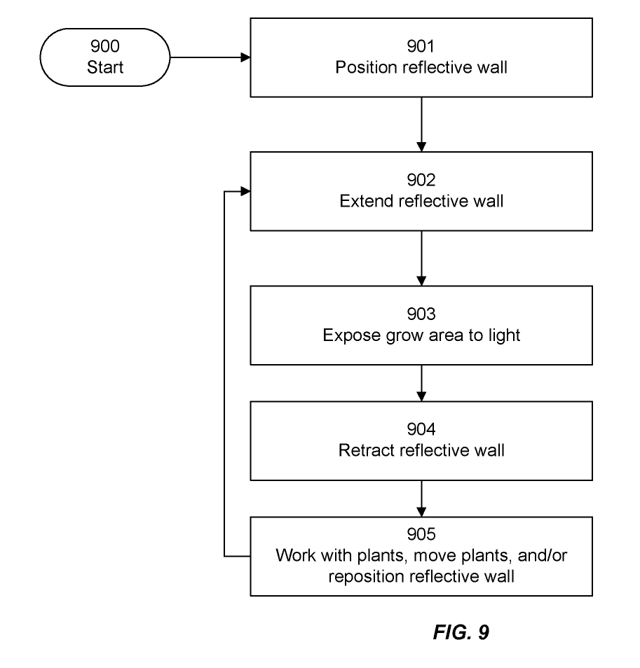

Referring now to FIG. 9, there is shown a flow diagram depicting a method of using a retractable reflective wall 100, according to one embodiment of the present invention. The user positions 901 retractable reflective wall 100 as desired. Retractable reflective wall 100 can be secured at the desired position, for example by attachment to a wall, ceiling, or fixture, or by suspension via wire, cord, twine, or the like. The user extends 902 wall 100 so as to expose sheet 131 so that reflective surface 101 reflects light onto the grow area. Extension 902 of wall 100 can be performed, for example, by pulling down on sheet 131 so that it unrolls from roller assembly 106, or by some other mechanism. In one embodiment, wall 100 is held in the extended position by cog catch 805, and/or by brake assembly 1001, and can be further stabilized by the use of weighted rod 105, pull-down fasteners 104, and/or other components. One skilled in the art will recognize that steps 901 and 902 can be performed in any sequence; for example, reflective wall 100 can be extended 902 prior to positioning 901 of reflective wall 100. In addition, adjustments to the position of reflective wall 100 can be made at any time.

Plants 203 in the grow area can now be exposed 903 to light from a source such as lamp 201. Wall 100 serves to reflect light toward the grow area. If the user wishes to work in the grow area and/or to move wall 100, he or she retracts 904 wall 100. As described above in connection with FIGS. 4 through 8, in one embodiment, wall 100 can be self-retracting, so that retraction 904 is initiated by tugging on the bottom edge of sheet 131, causing cog catch 805 to release and allowing spring 711 to rotate cylinder 701. Alternatively, as described above in connection with FIGS. 10 through 12, the user can pull on chain 1012 to reduce friction between the components of brake assembly 1001, thus allowing spring 1210 to rotate spring axle 1204 and thereby retract sheet 131. Other mechanisms can be used for extension and retraction of sheet 131; for example in yet another embodiment, two chains or cords can be provided; pulling on one causes sheet 131 to be extended, and pulling on the other causes sheet 131 to retract.

Once sheet 131 has been retracted, the user can work 905 with plants 203 in the grow area, move plants 203, and/or reposition wall 100. If the user wishes to re-expose the grow area to light, the method returns to step 902.

Retractable reflective wall 100 of the present invention has numerous advantages over prior art techniques. It has the ability to retract into a small compact unit for ease of storage, movement, and/or reconfiguration. When in use, it expands into a large highly-reflective surface for the purpose of redirecting grow light in an agricultural setting.

In addition, the retracting feature makes retractable reflective wall 100 ideal for working in a grow area, as one can retract sheet 131 while working or while plants are being sprayed, then pull sheet 131 back down to its extended position when finished working. Thus, accumulation of dirt, water, or other chemicals on reflective surface 101 can be avoided or reduced.

In the above description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

As will be understood by those familiar with the art, the invention may be embodied in other specific forms without departing from the spirit or essential characteristics thereof. For example, the particular architectures depicted above are merely exemplary of one implementation of the present invention. In one embodiment, the device of the present invention can be used for functions other than for providing light to a grow area.

The functional elements and method steps described above are provided as illustrative examples of one technique for implementing the invention; one skilled in the art will recognize that many other implementations are possible without departing from the present invention as recited in the claims. Likewise, the particular capitalization or naming of the modules, protocols, features, attributes, or any other aspect is not mandatory or significant, and the mechanisms that implement the invention or its features may have different names or formats. In addition, the present invention may be implemented as a method, process, user interface, computer program product, system, apparatus, or any combination thereof. Accordingly, the disclosure of the present invention is intended to be illustrative, but not limiting, of the scope of the invention, which is set forth in the following claims.

What is claimed is:

1. A retractable reflective wall, comprising:
a roller assembly comprising a rotatable cylinder;
a support mechanism, for supporting the roller assembly;
a flexible sheet affixed to the roller assembly and having at least one reflective surface;
wherein:
the flexible sheet has an extended position wherein at least a portion of the reflective surface is exposed so as to reflect light onto an area; and
the flexible sheet has a retracted position wherein the flexible sheet rolled onto the cylinder.

2. The retractable reflective wall of claim 1, wherein, in the extended position, the flexible sheet is oriented so as to reflect light into an area for growing plants.

3. The retractable reflective wall of claim 1, wherein, in the retracted position, the flexible sheet is substantially hidden from view.

4. The retractable reflective wall of claim 1, wherein the support mechanism comprises a housing, and wherein the roller assembly is affixed to the housing.

5. The retractable reflective wall of claim 1, wherein the support mechanism comprises a support beam, and wherein the roller assembly is affixed to the support beam.

6. The retractable reflective wall of claim 1, wherein the roller assembly further comprises a self-retraction mechanism for selectively causing the cylinder to automatically rotate so as to retract the flexible sheet.

7. The retractable reflective wall of claim 6, wherein the self-retraction mechanism comprises a ratcheting spring assembly.

8. The retractable reflective wall of claim 6, wherein the self-retraction mechanism comprises:
a spring, for selectively exerting rotational force onto the rotatable cylinder in a direction causing retraction of the flexible sheet; and
a cog catch, capable of being engaged to temporarily prevent the rotatable cylinder from rotating, and further capable of being disengaged to allow rotatable cylinder to rotate.

9. The retractable reflective wall of claim 6, wherein the self-retraction mechanism comprises:
a spring, for selectively exerting rotational force onto the rotatable cylinder in a direction causing retraction of the flexible sheet; and
a braking mechanism, capable of being engaged to temporarily prevent the rotatable cylinder from rotating, and further capable of being disengaged to allow rotatable cylinder to rotate.

10. The retractable reflective wall of claim 9, wherein the braking mechanism comprises:
a first surface coupled to the rotatable cylinder; and
a second surface;
and wherein the braking mechanism is engaged by contact between the surfaces.

11. The retractable reflective wall of claim 9, wherein the braking mechanism comprises:
a cone coupled to the rotatable cylinder; and
a socket for engagement with the cone;
and wherein the braking mechanism is engaged by contact between the cone and the socket.

12. The retractable reflective wall of claim 9, further comprising:
a chain, coupled to the braking mechanism for allowing the user to selectively engage the braking mechanism.

13. The retractable reflective wall of claim 1, further comprising:
a motorized mechanism for selectively rotating the cylinder so as to extend and retract the flexible sheet.

14. The retractable reflective wall of claim 1, further comprising:
a weight, affixed to the flexible sheet.

15. The retractable reflective wall of claim 1, further comprising:
at least one fastening device, for attaching an edge of the flexible sheet to a surface when the flexible sheet is in the extended position.

16. The retractable reflective wall of claim 1, wherein the support mechanism is suspended.

17. The retractable reflective wall of claim 1, further comprising:
a stand for supporting the support mechanism.

18. The retractable reflective wall of claim 1, wherein the flexible sheet further comprises a backing material.

19. The retractable reflective wall of claim 18, wherein the backing material comprises vinyl.

20. The retractable reflective wall of claim 1, wherein the support mechanism is affixed to at least one selected from the group consisting of:
a ceiling;
a wall;
a furniture item; and
a fixture.

21. A method of extending a retractable reflective wall, comprising:
positioning a support mechanism for the retractable reflective wall;
extending, from the support mechanism, a flexible sheet having at least one reflective surface, so as to cause the reflective surface to reflect light onto a grow area;
exposing the grow area to light reflected by the flexible sheet; and
retracting the flexible sheet.

22. The method of claim 21, wherein:
positioning a support mechanism comprises positioning a roller assembly, wherein the flexible sheet is affixed to the roller assembly;
extending the flexible sheet comprises unrolling a flexible sheet from the roller assembly; and
retracting the flexible sheet comprises rolling the flexible sheet onto the roller assembly.

23. The method of claim 21, further comprising, after extending the flexible sheet, attaching an edge of the flexible sheet to a surface.

24. The method of claim 21, wherein:
extending the flexible sheet comprises engaging a cog catch to temporarily prevent retraction of the flexible sheet; and
retracting the flexible sheet comprises disengaging the cog catch to allow retraction of the flexible sheet.

25. The method of claim 21, wherein:
extending the flexible sheet comprises engaging the brake mechanism to temporarily prevent retraction of the flexible sheet; and
retracting the flexible sheet comprises disengaging the brake mechanism to allow retraction of the flexible sheet.
